(19) United States
(12) Patent Application Publication
(10) Pub. No.: US 2025/0114848 A1
(43) Pub. Date: Apr. 10, 2025

(54) STATIONARY MACHINE TOOL

(71) Applicant: C. & E. Fein GmbH, Schwaebisch Gmuend, Bargau (DE)

(72) Inventors: Sergej DENZEL, Schwaebisch Gmuend (DE); Stefan SCHERRENBACHER, Waldstetten (DE)

(73) Assignee: C. & E. Fein GmbH, Schwaebisch Gmuend, Bargau (DE)

(21) Appl. No.: 18/907,153

(22) Filed: Oct. 4, 2024

(30) Foreign Application Priority Data
Oct. 4, 2023 (EP) 23201542.0

(51) Int. Cl. B23B 51/04

(52) U.S. Cl. CPC B23B 51/0453; B23B 2251/4012; B23B 2260/036; B23B 2260/10; B23B 2270/30; B23B 2270/38

(57) ABSTRACT

A stationary machine tool for machining, in particular core drilling, comprising a tool stand with a first tool stand housing interior. A chip guidance system comprises a magnet, wherein the magnet is arranged in the first tool stand housing interior such that chips produced by a machining process and entering the first tool stand interior are deflected by the chip guidance system.

This nonprovisional application claims priority under 35 U.S.C. § 119(a) to European Patent Application No. 23201542.0, which was filed on Oct. 4, 2023, and which is herein incorporated by reference.

### BACKGROUND OF THE INVENTION

### Field of the Invention

The invention relates to a stationary machine tool, in particular a core drill.

### Description of the Background Art

In the machining of workpieces, metal chips or metal dust are a ubiquitous by-product that forms during various phases of the machining process. These small, sharp-edged metal fragments inevitably occur when material is removed from a workpiece, for example by a stationary machine tool. If there is insufficient control and prevention, this can be a source of potential problems. In particular, it can be critical if the free-flying chips get into the interior of machine tools or stationary machine tools.

The effects of these free-flying chips or metal particles in the vicinity of critical components of machinery are extremely complex. They can cause immediate production disruptions by hindering the movement of machine tool parts or causing damage to the machined workpieces.

In addition, the long-term effects of free-flying chips on the stationary machine tools themselves are of considerable importance. Small metal fragments or metal particles can penetrate machine components, which can lead to premature wear and damage. The mechanics and electronics of machines are sensitive and can be affected by the presence of chips.

In particular in stationary machine tools, which are essential for precise machining of workpieces, the problem of free-flying chips is exacerbated. These machines are characterized by high speeds and accuracy requirements. The chips can enter into the guide systems, bearings or electronics and impair both the mechanical precision and the electronic control. Ensuring the optimal performance of stationary machine tools is crucial as they are the basis for high-quality manufacturing processes and products.

Thus, there is a need for measures to reduce or avoid chips in the vicinity of critical components in a machine housing interior of a stationary machine tool.

### SUMMARY OF THE INVENTION

It is therefore an object of the invention to provide a stationary machine tool for machining.

The advantage of the invention is that the stationary machine tool includes a chip guidance system, which provides an effective method of controlling chips. By positioning at least one magnet in such a way that it deflects, or in particular attracts, chips are prevented from spreading uncontrollably inside the machine. This process is of particular importance because it not only ensures the safety and stability of the work process, but also brings a variety of advantages. The chip guidance system preferably has at least one chip guide component, in particular at least one wall component arranged in the interior of the tool stand housing, a deflection panel, a guide channel.

The stationary machine tool for machining, in particular a core drill, can have a tool stand with a first tool stand housing interior.

Furthermore, the stationary machine tool, in particular the chip guidance system, can have at least one or exactly one magnet, wherein the magnet is arranged in such a way in the first tool stand housing interior that chips entering the tool stand housing interior and induced by a machining process are deflected by the magnetic field induced by the magnet.

A stationary machine tool in the sense of the invention is an industrial machine used in the manufacturing and metalworking industries. Machines, which are set up in a fixed position for the purpose of their use, in contrast to portable or movable or hand-held tools, which are referred to as “standing” or “stationary” machine tools.

Stationary machine tools are used for a variety of machining and manufacturing processes, including turning, milling, drilling, grinding, sawing, and more. They enable the precise removal of material from workpieces to achieve desired shapes, dimensions and surface qualities.

Stationary machine tools are usually highly specialized and powerful equipment that is used for the production of precision parts in large quantities or for customized one-off productions.

The positioning of a stationary tool machine in the manufacturing process on a base or table can be force-locked by a magnet or by other fasteners such as screws or clamps.

Machining in the sense of the invention is a process in the manufacturing industry in which material is removed from a workpiece by removing it in the form of chips or layers. This material removal is typically carried out by the use of tools such as lathes, milling machines, drilling machines, grinding machines, saw machines and other machine tools.

Machining is used to bring workpieces into the desired shape, size and surface quality. This can include removing excess material to produce precision parts or improving surface quality for aesthetic or functional purposes.

The process is often multi-step, with the tool removing layers of the material in the form of chips. These chips are small metal fragments, metal particles or layers that are created during the machining process. Machining requires precision and careful control to achieve the desired results.

A core drill in terms of the invention, also known as a core drilling machine or core drilling rig, is a specialized machine tool. Its main purpose is to precisely drill circular indentations or cores in workpieces while keeping the surrounding material intact. This allows for the creation of clean and accurate openings without damage or burrs at the edge.

A tool stand for holding a stationary machine tool in terms of the invention is a device that is used to position stationary machine tools safely and stably. This structure is used to firmly anchor the machine during operation and to create an optimal working environment. Key features include stability and safety, as the tool stand provides a fixed platform for the stationary machine tool. This ensures that the machine does not wobble or generate vibration during operation, which is crucial for precise machining. Tool stands can be equipped with a magnetic base to provide a secure grip.

In some cases, tool stands are also mobile, which can increase the mobility of the stationary machine tool when required. They contribute to optimizing the available working space and ensuring efficient and safe operation. Overall, the tool stand plays a crucial role in creating a stable and safe working environment for stationary machine tools, which is of great importance for precise machining and quality control.

The interior of the tool stand housing for the purposes of the invention is a part of the tool stand which contains various components such as electronic equipment.

A magnet in the sense of the invention is a physical object or material which has the ability to attract or reject ferromagnetic or magnetizable substances. Magnets have the ability to create a magnetic field around them that acts on other magnets or magnetic materials.

In the first tool stand housing interior, at least one magnet is placed and arranged in such a way that it fulfils an important function in machining operations. The magnetic field generated by this at least one, preferably several magnets, in particular exactly one, two, three, four or up to ten magnets, serves to specifically guide or deflect chips that are produced during the process and enter into the tool stand housing interior.

During the machining process, metallic chips or particles can be generated. If they were to spread freely in the housing interior, these could potentially cause damage or impair the functionality of tools or electronic components.

The magnet in the interior of the tool stand housing counteracts this problem through the effect of its magnetic field. This magnetic field exerts an attractive force on the magnetic chips and deflects them in a certain direction. Thereby, chips are directed away from sensitive areas of the housing, tools or electronic components where they could otherwise cause damage.

Overall, the arrangement of the magnets in the interior of the tool stand housing helps to improve safety, efficiency and functionality of the machining process and the tools and electronic equipment contained therein by enabling control over free-flying chips.

Advantageously, the stationary machine tool also can have a motor and a motor cable. The motor cable of the motor runs to the first tool stand housing interior along a guide channel.

A motor in the sense of the invention is an electric or pneumatic drive unit developed to perform machining operations in various materials. These drive units provide the required power and precision for creating holes in workpieces or other machining, for example.

A motor cable in the sense of the invention is a component of the drive unit or a machine for machining. It is the electrical cable that connects the drive unit to the power supply and enables the transmission of electrical energy.

The motor cable runs from the drive unit to the first tool stand housing interior along a specially designed guide channel. This guide channel is used to guide and protect the cable safely during the material removal process.

Advantageously, the stationary machine tool also can have a second tool stand housing interior with an electronic unit located inside. The first and second tool stand housing interiors are preferably separated by a partition wall. The second tool stand housing interior is connected to the first tool stand housing interior, preferably via the partition wall, wherein the partition wall has at least one opening, so that there is a connection from the motor to the electronic unit by means of the motor cable.

Advantageously, the tool stand housing interior of the stationary machine tool can be divided into two areas by a partition wall. The electronics unit is preferably located in a second interior of the tool stand housing. This electronic unit can be attached to the partition wall. In the first interior of the tool stand housing, the motor cable is preferably arranged in a loop-like manner. The length of the loop of the motor cable in the first interior is preferably dependent on the position of the motor. In the working process, the motor moves vertically from a starting position in the direction of the workpiece to a final position in order to use the tool to machine the workpiece. In the starting position, most of the motor cable is preferably located outside the second interior, whereas in the end position, most of the motor cable is located in the second interior of the tool stand housing.

The motor cable preferably reaches with its first end through an opening in the partition wall into the second interior of the tool stand housing and is connected to the power source and the electronic unit. The second end of the motor cable preferably runs through the guide channel and is connected to the motor.

The partition wall can contain openings that create fluid connections between the first and second interior of the tool stand housing. This allows for the electronic unit to be cooled by air currents, for example.

An electronic unit in the sense of the invention refers to a component or module that performs electronic functions and tasks of the stationary machine tool. Electronic units can be used in a wide range of applications and are used to process, control or monitor electronic signals.

A partition wall in the sense of the invention can be a structure or component that serves to divide a room into separate sections or areas. The partition wall can be made of different materials. The partition wall can be made of plastics, metallic and/or magnetic materials or a combination of these. This design, while allowing for electronics to be integrated into the work process, carries the risk that chips or particles could enter the second tool stand housing interior, where the electronic unit is located, during machining operations. These chips could potentially impair the function of the electronic unit or cause damage.

The openings in the partition wall can be a potential entry opening for chips. If chips get into the first tool stand housing interior and reach the electronic unit through the openings, there is a risk of faults, malfunctions or even permanent damage to the electronic components.

A magnet can be placed in the area of the openings of the partition wall between the second tool stand housing interior, which contains the electronics unit, and the first tool stand housing interior. This magnet creates a magnetic field that acts on the metal chips that are formed during the machining process.

The metal chips that come near the openings of the partition wall can be attracted by the magnetic field and led away from the opening. This prevents the chips from entering the second tool stand housing interior, where the sensitive electronics unit is located.

In this way, the electronic unit can be protected from the potential negative effects of chips, while maintaining the necessary connection between the motor and the electronic unit.

Advantageously, the magnet can be attached to the partition wall. The advantage of fastening the magnet to the partition wall between the first tool stand housing interior and the second tool stand housing interior is that it provides effective protection against metal chips while maintaining the presence of openings between the motor and the electronic unit.

Advantageously, the first tool stand housing interior is partially formed by a removable tool housing cover. The tool housing or housing cover may have a locking flap that can be opened, in particular removed. The locking flap can also close a compartment in the tool stand housing interior, wherein the at least one magnet can be arranged in the said compartment.

A locking flap can be a movable cover that is set up to be easy to open and close, while also providing a locking function to control or limit access to a specific area. The housing cover and/or locking flap makes it possible to reach the interior of the first tool stand housing interior if necessary. This can be especially useful for performing maintenance, making repairs, or replacing components. The locking function of the flap also provides security by restricting unauthorized access to the interior of the housing. The possibility to open the case cover or the locking flap also facilitates maintenance and servicing of components inside the housing.

Advantageously, the magnet can be accessible after removing the housing cover and/or the locking flap. Metal particles that adhere to the magnet can be easily removed. In addition, the magnet is reversibly removable. The advantage of being able to clean or reversibly remove the magnet after removing the housing cover or the locking flap is due to the flexibility and adaptability of this configuration. This property allows for easy modification of the system without the need for major structural changes. Alternatively, the magnet can also be attached to the housing cover or the locking flap.

If maintenance, repairs or adjustments are required inside the first tool stand housing interior, the housing cover or locking flap can be easily removed to provide access. This facilitates the maintenance and repair of components and minimizes system downtime.

Advantageously, the motor cable runs through a, in particular elongated opening of the tool stand housing interior, which forms part of the guide channel. If the motor cable runs through an elongated opening, which forms part of the guide channel, this offers the advantage of a safe and protected cable route. This configuration contributes to the safety and efficiency of operation by protecting the motor cable from damage, entanglement or malfunction. The cable is routed in an orderly manner, which prevents accidents, extends the life of the cable and increases the efficiency of workflows. The guide channel is used in particular to flexibly guide the motor cable in the direction of the cable route. Typically, the unit formed by the motor, a connected gearbox, a tool holder and a tool is flexibly vertical in the case of a stationary machine tool, or at an almost vertical angle in relation to the tool stand, in particular in that the unit is flexibly arranged vertically on the tool stand by means of a longitudinal guidance system, in particular a rail system.

In particular, in the case that the stationary machine tool is a drill or a core drill, the motor can also be called a drill motor and the motor cable is also called a drill motor cable.

Advantageously, the guide channel can have a cover connected to a film hinge. If the guide channel has a cover that is attached to a film hinge, this provides the advantage of improved accessibility and ease of maintenance of the system. The cover can be easily opened to allow access to the cable and other components inside the guide channel without completely having to remove the cover. This facilitates quick maintenance or repair, minimizes downtime and increases the efficiency of the system.

The film hinge ensures a secure closure of the cover when it is not open and protects the cable from external influences such as dirt, moisture or mechanical wear. This extends the life of the cable and reduces maintenance costs.

In addition, the cover helps to keep the work area clean and tidy, as it neatly covers the cable and prevents accidents caused by cables lying around. The avoidance of entanglements or disruptions due to external influences ensures smooth operation of the system.

Advantageously, the magnet can be arranged in a cylindrical bearing and extends into the first tool stand housing interior. The advantage of having the magnet arranged in a cylindrical bearing and extending into the first tool stand housing interior is that this provides a targeted and efficient deflection of chips while making optimal use of the available space in the tool stand housing interior.

The cylindrical bearing allows for the magnet to be precisely positioned to deflect chips generated during the machining process in a targeted manner. This is particularly important to ensure that the chips are kept away from sensitive components and do not cause interference or damage.

The optimized use of space is another advantage of this arrangement. Because the magnet is housed in a cylindrical bearing, the available space in the tool stand housing interior is used efficiently without wasting space. This is especially useful if there are other components or mechanisms that need to be accommodated in that space.

In addition, this arrangement provides protection for sensitive components inside the tool stand housing interior. The magnet can help protect these components from chips and metallic, magnetic particles, which ensures the longevity and proper functioning of these parts.

Advantageously, the first tool stand housing interior can have an upper area and a lower area, which are separated by an imaginary horizontal separation plane. The opening for the motor cable is preferably located in the upper area, the magnet is preferably located in the lower area. Chips entering through the opening at the top will, following gravity, fall from top to bottom and get into the attraction range of the magnet, which then secures the chips. Preferably, the lower area has a bottom-side floor area, which occupies the lower half or the lower quarter of the lower area. Preferably, the magnet is located in the floor area, which is particularly effective because chips collect in the floor area.

Advantageously, the first tool stand housing interior can have an upper area and a lower area relative to an axis below. Relative to the axis below in the sense of the invention means that the area is arranged at least substantially along an axis along the force vector of gravity below.

Advantageously, the magnet can be located in the lower area.

Advantageously, the magnet can be a permanent magnet. The advantage of the magnet being a permanent magnet in this context and extending into the first tool stand housing interior is that this magnet provides a durable and reliable solution without relying on an external power supply. Permanent magnets in the sense of the invention continuously generate a magnetic field that efficiently deflects chips without the need to supply electricity. This results in a reliable and cost-effective way to protect the interior of the tool stand housing and to safeguard sensitive components from metallic particles. Since no external power source is required, maintenance and operating costs associated with power supply are also eliminated, reducing the total operating costs. This is particularly beneficial in industrial applications where a reliable and cost-effective solution for the protection of electronic components from magnetic particles is required.

Advantageously, the magnet can be an electromagnet. The advantage of the magnet being an electromagnet in this context and extending into the first tool stand housing interior is that it corresponds to the advantage of a permanent magnet in terms of targeted and efficient deflection of chips as well as optimized use of space. However, electromagnets offer additional advantages due to their controllability. An electromagnet in the sense of the invention can turn the magnetic field on and off as needed, allowing for precise control of a chip guidance system. This adaptability is particularly useful for optimizing the protection of sensitive components and increasing the efficiency of the system.

The ability to set the electromagnet to an energy-saving mode when there is no need for a chip guidance system helps to reduce energy consumption and operating costs. This makes electromagnets an efficient and cost-effective solution.

Advantageously, the magnet can be a two-pole neodymium magnet with a diameter of more than 5 mm, preferably more than 10 mm, further preferred more than 20 mm.

Advantageously, the magnet can be arranged via a snap-on mechanism, form-fitting or adhesive, firmly bonded or magnetic, or via another magnet or a combination of these fastening methods.

These fastening methods allow for uncomplicated installation of the magnet in the tool stand housing interior. This saves time and effort when setting up the system and enables quick commissioning.

The modularity provided by snap-on mechanisms, adhesive attachments or other magnets allows for the magnet to be easily removed or replaced if necessary. This increases the flexibility of the system and facilitates customization according to specific requirements.

The use of these fastening methods does not cause permanent changes or damage to the tool stand housing interior. This is particularly important if dismantling capability or the possibility of system adaptation is desired.

Ease of maintenance is improved as the magnet can be easily cleaned, removed and serviced as needed without any significant effort. This minimizes downtime and increases the efficiency of the system.

The adaptability of the fastening method makes it possible to choose the most suitable method for the specific application. This ensures that the magnet is positioned securely and stably in the tool stand housing interior.

Overall, snap-on mechanisms, adhesive attachments or other magnets provide a practical and versatile solution for attaching the magnet to the interior of the tool stand housing, which contributes to flexibility, ease of maintenance and efficiency of the system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows a perspective view of a stationary machine tool;

FIG. 1b shows a perspective view of the stationary machine tool from FIG. 1a;

FIG. 2 shows a partial perspective view of the stationary machine tool from FIG. 1a;

FIG. 3 shows a partial perspective view of the stationary machine tool according to FIG. 2 with a transparent partition wall;

FIG. 4 shows an enlarged partial perspective view according to FIG. 3; and

FIG. 5 shows another perspective view of the stationary machine tool from FIG. 1a.

### DETAILED DESCRIPTION

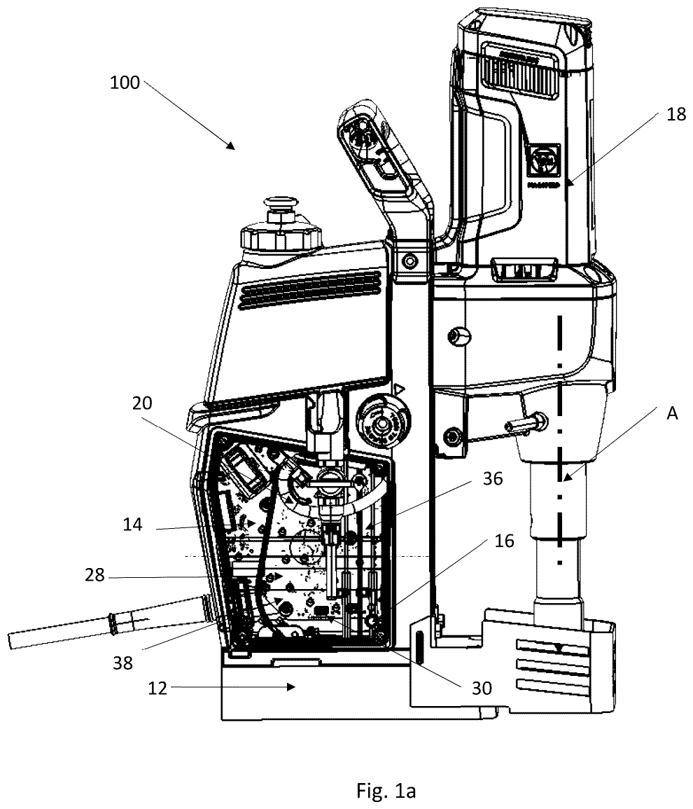

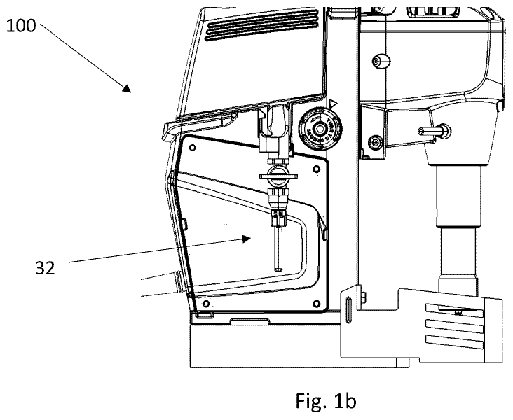

FIG. 1a shows a view of a stationary machine tool 100 in the form of a core drill. This machine 100 has a tool stand 12 in which there is a first tool stand housing interior 14, which is accessible by removal of the housing cover 32 (FIG. 1b). The chip guidance system, which contains a magnet 16, is strategically placed in this interior 14 in order to direct the chips generated during drilling processes that enter the interior of the tool stand housing 14 through its induced magnetic field.

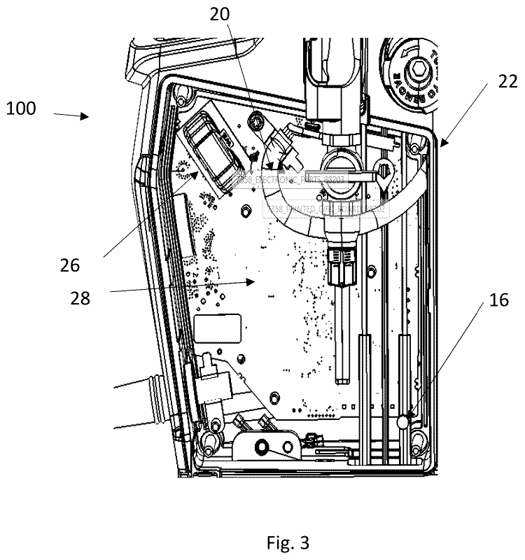

The stationary machine tool 100 is also equipped with a motor 18, which is designed as a drill motor 18 in the example shown, and a motor cable 20, which is designed as a drill motor cable 20 in the example shown. This cable runs along a guide channel 22 (FIG. 3) and extends from the drill motor 18 via the first 14 to the second tool stand housing interior 24. This guide channel 22, which is assigned to the chip guidance system, restricts the access of chips into the first tool stand housing interior 14 and influences the direction of the incoming chips.

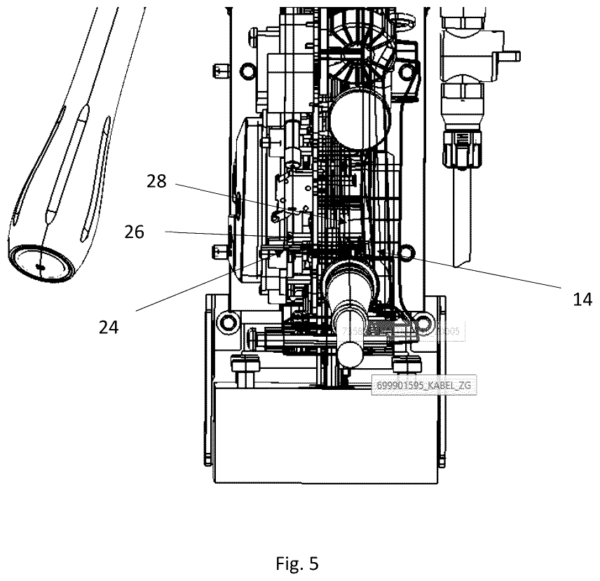

Furthermore, a second tool stand housing interior 24 (FIG. 5) is provided in the stationary machine tool 100 shown, in which an electronic unit 26 is disposed. This second tool stand housing interior 24 is connected to the first tool stand housing interior 14 via a partition wall 28. The partition wall 28 also has at least one opening 30. The openings 30 represent a connection between the drill motor 18 and the electronic unit 26. In particular, this connection represents a fluid connection along which a metal particle can come into close contact with the electronic unit 26.

In the example shown, the magnet 16 is attached to the partition wall 28. The first tool stand housing interior 14 is partly formed by a removable housing cover 32, see FIG. 1b, which increases accessibility and eases maintenance in this area. The first tool stand housing interior 14 has an upper area 36 and a lower area 38 below it relative to a dash-dotted line in FIG. 1. In the example shown, the magnet 16 is arranged in the lower area 38, in particular in the floor area.

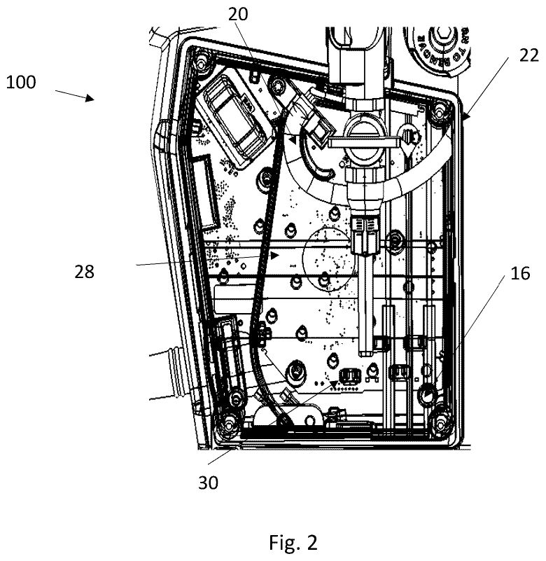

FIG. 2 shows a partial view of the stationary machine tool 100 from FIG. 1a, wherein in this partial view the area around the partition wall 28 is enlarged. The drill motor cable 20 runs along the guide channel 22 and extends from the drill motor 18 to the first tool stand housing interior 14. Through this guide channel 22, metal particles or chips can enter the first tool stand housing 14 to a limited extent.

A height adjustment along axis A (FIG. 1) causes movement of the drill motor cable 20 within the first tool stand housing interior 14. The movement of the drill motor cable 20 allows for metal particles that adhere to the drill motor cable or are located in or in the area of the guide channel 22 to enter the first tool stand housing interior 14 in the direction of movement.

Due to the placement of the magnet 16 and its induced magnetic field, chips that enter the first interior of the tool stand housing are guided and held force-locked in the magnetic field. This prevents or at least reduces the number of metal particles that pass through openings 30 and protects critical components such as the electronic unit 26 from unwanted contact with these metal particles or chips.

FIG. 3 shows a partial view of the stationary machine tool 100 according to FIG. 2 with a transparent partition wall 28. FIG. 3 thus differs from FIG. 2 in that the electronic unit 26 is visible. It can be clearly seen how the electronic unit 26 is arranged in the second tool housing interior 24. Free-flying chips can thus come into undesirable contact with the electronic unit 26 within the second tool housing interior 24 and adversely affect the operation of the stationary machine tool 100.

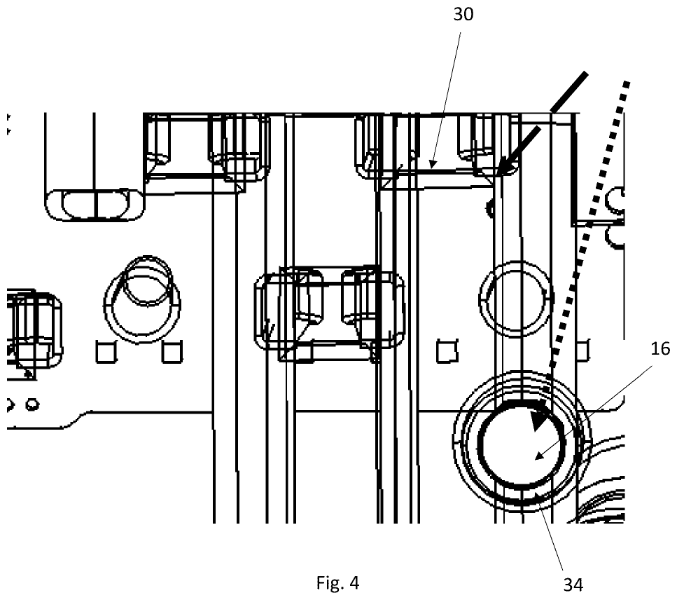

FIG. 4 shows an enlarged partial view according to FIG. 3. The lined interrupted arrow shows a potential path of a chip through one of the openings 30. If the chip passes through one of the openings 30, it can enter into harmful contact with electronic components such as the electronic component 26 described. The magnetic field of the magnet 16, which is arranged in a bearing 34, deflects the chip onto a trajectory induced by the dotted arrow and thus prevents it from reaching the second tool stand housing interior 24 through the openings 30. In the example shown, the magnet 16 is a neodymium magnet with a diameter of 5 mm.

FIG. 5 shows another view of the stationary machine tool 100, with the machine rotated 90° along the axis A and essential components such as the locking flap hidden. The second tool stand housing interior 24 with an electronic unit 26 arranged in it can be seen, wherein the second tool stand housing interior 24 is connected to the first tool stand housing interior 14 via a partition wall 28. The partition wall 28 has several openings 30, so that there is a connection between the drill motor 18 and the electronic unit 26, through which a chip can come close to the electronic unit 26.

Chips entering the first tool stand housing interior 14 are deflected by the chip guidance system, in particular by the magnetic field induced by the magnet 14.

Overall, the chip guidance system, with its arrangement of guide channel 22 and magnet 16 with its magnetic field in the interior of the tool stand housing 14, thus contributes to improving the safety, efficiency and functionality of the drilling operation and of the tools and electronic equipment contained therein, by enabling the trajectories of free-flying chips to be influenced.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A stationary machine tool for machining, a core drill, the machine tool comprising:
a tool stand with a first tool stand housing interior;
a chip guidance system comprising at least one magnet and a magnetic field induced by the at least one magnet, the at least one magnet in the first tool stand housing interior being arranged such that chips created by a machining process and entering the first interior of the tool stand housing are deflected by the chip guidance system;
a motor;
a second tool stand housing interior with an electronic unit arranged therein; and
a partition wall separating the second tool stand housing interior from the first tool stand housing interior, the partition wall comprising at least one opening so that there is a connection between the motor and the electronic unit, wherein the magnet is attached to the partition wall.

2. The stationary machine tool according to claim 1, further comprising a motor cable, wherein the motor cable runs from the motor to the first tool stand housing interior along a guide channel that is a part of the chip guidance system.

3. The stationary machine tool according to claim 1, wherein the first tool stand housing interior is partly formed by a removable housing cover.

4. The stationary machine tool according to claim 3, wherein the magnet is adapted to be reversibly removed after removal of the housing cover.

5. The stationary machine tool according to claim 2, wherein the drill motor cable runs through an elongated opening, which forms part of the guide channel.

6. The stationary machine tool according to claim 2, wherein the guide channel has a cover connected to a film hinge.

7. The stationary machine tool according to claim 1, wherein the magnet is arranged in a cylindrical bearing and extends into the first tool stand housing interior.

8. The stationary machine tool according to claim 1, wherein the first tool stand housing interior has an upper area and a lower area relative to a dashed line below.

9. The stationary machine tool according to claim 1, wherein the magnet is arranged in the lower area.

10. The stationary machine tool according to claim 1, wherein the magnet is a permanent magnet.

11. The stationary machine tool according to claim 1, wherein the magnet is an electromagnet.

12. The stationary machine tool according to claim 1, wherein the magnet is a two-pole neodymium magnet with a diameter of more than 5 mm, or more than 10 mm, or more than 20 mm.

13. The stationary machine tool according to claim 1, wherein the magnet is arranged by a snap-on mechanism in a form-fitting manner or by an adhesive attachment in a firmly bonded or magnetic manner or via another magnet.
